(19) United States
(12) Patent Application Publication
(10) Pub. No.: US 2013/0123000 A1
(43) Pub. Date: May 16, 2013

(54) GAME APPARATUS

(71) Applicants: Kazuhiro Kusuda, Minato-ku (JP); Takashi Uchiyama, Minato-ku (JP); Shogo Azuma, Minato-ku (JP); Shinya Ito, Minato-ku (JP); Hirokatsu Yamaguchi, Minato-ku (JP); Hiroki Nakasato, Minato-ku (JP); Kensaku Yoshida, Minato-ku (JP)

(72) Inventors: Kazuhiro Kusuda, Minato-ku (JP); Takashi Uchiyama, Minato-ku (JP); Shogo Azuma, Minato-ku (JP); Shinya Ito, Minato-ku (JP); Hirokatsu Yamaguchi, Minato-ku (JP); Hiroki Nakasato, Minato-ku (JP); Kensaku Yoshida, Minato-ku (JP)

(73) Assignee: KONAMI DIGITAL ENTERTAINMENT CO., LTD., Minato-ku, Tokyo (JP)

(21) Appl. No.: 13/812,778

(22) PCT Filed: Aug. 30, 2011
(86) PCT No.: PCT/JP2011/069530

§ 371 Date: Jan. 28, 2013

(30) Foreign Application Priority Data
Sep. 3, 2010 (JP) 2010-197677

(51) Int. Cl. G07F 17/32

(52) U.S. Cl. CPC G07F 17/3244
USPC 463/25

(57) ABSTRACT

A game apparatus has an operation unit and a radio communication unit for performing radio communication with the outside and a connection unit that establishes a connection with an external terminal device via the radio communication unit, and stores the number of credits in association with a player ID obtained and also stores this player ID in association with a terminal ID of the external terminal device for which the connection has been established by the connection unit. Also, the game apparatus controls a first game that advances based on an operation of the operation unit while consuming credit corresponding to a player ID and a second game that advances while consuming credit corresponding to a player ID that is associated with the terminal ID of the external terminal device for which the connection has been established by the connection unit so that the first game and the second game advance simultaneously. The game apparatus reduces the number of credits corresponding to the player ID depending on credit consumed respectively in the first and the second game.

### TECHNICAL FIELD

The present invention relates to a game apparatus by which it is possible to play a game remotely.

### BACKGROUND ART

Patent Document 1 discloses a game system in which a game played in recreation facilities such as game centers (game halls) can be played using portable terminals. According to this system, even if there is no available game terminal (individual game terminal) sited at the recreation facilities, a player is able to remotely play a game by using a portable terminal instead of using an individual game terminal.

### PRIOR ART

### Patent Document

Patent Document 1 JP-A-2008-220598

### DISCLOSURE OF INVENTION

### Problems to be Solved by the Invention

However, in the above system, a single player cannot advance a play using an individual game terminal and a play using a portable terminal simultaneously.

Accordingly, the present invention has as an object to provide a game apparatus for enabling a remote play, and a game apparatus for enabling a single player to simultaneously perform a remote play and a non-remote play.

### DISCLOSURE OF INVENTION

To solve the above-described problems, a game apparatus according to the present invention has an obtainer that obtains first identification information for uniquely identifying a player; a credit storage device that stores data indicating the number of credits for the first identification information obtained by the obtainer in association with the first identification information; a credit manager that increases the number of credits indicated by the data stored in the credit storage device by the deposit of a credit from the outside and reduces the number of credits by the consumption of credit in exchange for a game play; a radio communication unit adapted to perform radio communication; a connection unit that establishes a connection with an external portable terminal device through the radio communication unit; an identification information storage device that stores the first identification information obtained by the obtainer and second identification information assigned to the terminal device for which the connection has been established by the connection unit, the first identification information and the second identification information being stored in association with each other; an operation receiver that receives an operation of a player with respect to the game; and a game controller that controls a first game and a second game so that the first game and the second game advance simultaneously, the first game advancing based on the operation received at the operation receiver and advancing while consuming credit corresponding to the first identification information obtained by the obtainer and the second game advancing while consuming credit corresponding to the first identification information associated with the second identification information assigned to the terminal device for which the connection has been established by the connection unit, and the credit manager reduces the number of the credits corresponding to the first identification information obtained by the obtainer depending on the consumption of credits respectively in the first game and in the second game.

The game apparatus uniquely identifies a player, and the number of credits with respect to this player can be reduced by credit consumed in games (the first game and the second game) that can be advanced simultaneously with respect to this player. Additionally, the first game is controlled based on an operation of the operation unit (an operation received at the operation receiver), whereas the second game can be controlled based not on the operation of the operation unit. Therefore, a player can play the second game even at a place that is remote from the game apparatus (for example, at a smoking area in the game center) by using a portable terminal device.

Furthermore, in this game apparatus, although the first game is controlled based on the operation of the operation unit, the second game may be controlled based not on the operation of the operation unit. Therefore, according to this game apparatus, it is possible to simultaneously progress the first game controlled based on the operation of the operation unit and the second game controllable based not on the operation of the operation unit. Thus, a player can play the second game even if no operation unit is available.

Additionally, according to this game apparatus, a single player is able to play the first game and the second game simultaneously. In this case, because the first game advances while consuming credit corresponding to the first identification information of the player, and the second game advances while consuming credit corresponding to the second identification information associated with the first identification information (i.e., credit corresponding to the first identification information), the number of first identification information sets (i.e., player ID) required is one. Therefore, compared with a case in which plural sets of first identification information are assigned to a single player and in which the simultaneous plays of plural games are performed using these sets of first identification information, the work required for acquiring the first identification information can be reduced, and the management of first identification information can be made easier.

The first game that advances while consuming credit corresponding to the first identification information indicates a game that is played by a player with an operation unit while consuming credit corresponding to the first identification information after obtaining the first identification information by the obtainer. The second game that advances while consuming credit corresponding to the first identification information associated with the second identification information is a game that advances while consuming credit corresponding to the first identification information after storing the second identification information in association with the first identification information, the second identification information having been assigned to the terminal device for which the connection has been established by the connection unit. Therefore, the number of credits corresponding to the first identification information indicates the number of credits that decreases in exchange for the play in the first game and also indicates the number of credits that decreases in exchange for the play in the second game.

Also, the game apparatus may be configured so that even a player who has no IC card and whose player ID is unregistered is able to perform a play at the game apparatus by operating the game apparatus. However, such a game is not called the first game corresponding to the first identification information.

Furthermore, according to this game apparatus, a player can play the second game in associating with the first identification information that is the same as the first identification information of another player while the other player is playing the first game. Therefore, because a result of the play for the first game and a result of the play for the second game are managed in association with the same first identification information, various requests from players can be met such as allowing friends to play a game together. Also, a plurality of game apparatuses may be provided, so that these game apparatuses control different types of games from one another or so that one of plural types of games can be selected. As a result, a single player can simultaneously play plural types of games (simultaneous gameplays by a single player).

The “first identification information” uniquely identifies a player, and is identification information handled in the game apparatus. The first identification information may be a medium ID recorded in an IC card, or it may be an ID differing from the medium ID, with the ID being managed in advance in association with the first identification information. In a case in which the ID differing from the medium ID is used as the first identification information, the IC card can be disabled by disassociating the medium ID and the first identification information, even if the IC card is lost. Also, a new IC card may be issued so that a medium ID of the new IC card is reassociated with the first identification information, so that game values such as items and points that were associated with the first identification information in the past can be continuously used.

The “obtainer” is provided with, as a first example, a publicly known reader for reading a medium ID recorded in an IC card and a communication unit. In this case, the reader reads a medium ID, and the communication unit transmits this medium ID to a center server device. Having received this medium ID, the center server device returns the first identification information pre-associated with the medium ID. The first identification information is then received by the communication unit. A second example is a reader itself. In this case, the read medium ID is treated as the first identification information. A third example is an input unit for a player for directly inputting the first identification information.

The “second identification information” is information uniquely identifying a terminal device and is assigned to the terminal device. The second identification information is, for example, a communication address such as an IP (Internet Protocol) address or a MAC (Media Access Control) address.

The “radio communication unit” is, for example, a base unit (a radio base unit) of a wireless LAN (Local Area Network). The radio base unit preferably is one compliant with IEEE802.11 series that are in widespread use.

The “terminal device” is, for example, a wireless LAN adapter or handset, and more specifically is a portable game apparatus or a smart phone. A web browser-equipped device is preferred as a terminal device. In a case in which the terminal device uses a web browser in communicating with a game apparatus, the game apparatus will serve as a web server.

The “credit” is a game value that is exchanged for a game play. In a case in which an equivalent value of a play is one credit, the credit is equivalent to a right to play. For example, the credit is deposited from outside as a result of physically inserting or electrically transferring a medal or cash. Also, the credit is used and consumed in exchange for a play. A dispenser may be provided for, in response to an instruction from a player, dispensing credit for the player to the outside of the game apparatus. In this dispensing, a game medium such as a medal (token coin), ticket, coupon, or voucher corresponding to credit is dispensed from the game apparatus. Thus, different types of game media can be used for deposits and withdrawals, such as using a medal as a game medium for depositing credit and using a ticket as a game medium for dispensing credit.

“The number of credits” is the number or amount of credits, and it decreases when the credit is consumed and increases when the credit is granted. When an equivalent value for a single play is one credit, the number of credits is equal to the number of times the game can be played.

The “game” may be a bingo game, a horse racing game, or a video game (for example, a mahjong game or a role playing game, etc.).

This game apparatus may additionally have a status transmitter that transmits a progress status of the second game to the terminal device via the radio communication unit, and the game controller may control the second game to advance automatically in accordance with a predetermined rule. Alternatively, the game controller may control the second game based on an instruction from the terminal device.

In the game apparatus of the former case, it is possible to advance the second game automatically. A player who is not interested in the content of the game (a player who focuses only on a result of the game) would be satisfied even if the second game advances automatically. Also, according to the game apparatus of the former case, a player would be able to understand the progress status of the second game using an external portable terminal device. It is to be noted that the “predetermined rule” can be common to different sets of the second identification information (the first identification information) or may be established for each set of the second identification information (the first identification information).

According to the game apparatus of the latter case, a player is allowed to operate the second game using an external portable terminal device. That is, according to this game apparatus, the opportunity is increased for a player who is interested in the content of the game to play the game.

In each of the above game apparatuses, the connection unit, in a case in which the first identification information is obtained by the obtainer, may issue a password in association with the first identification information for display, and may store the first identification information and the second identification information in association with each other in the identification information storage device for the terminal device for which the password first agrees with a password for confirmation obtained from the terminal device since the password was issued, thereby establishing a connection with the terminal device.

In each of the above game apparatuses, the game may grant credit depending on a result of the game as a reward that can be obtained depending on the result of the game, and the credit manager may increase or reduce the number of the credits corresponding to the first identification information obtained by the obtainer depending on the consumption or the grant of credit respectively in the first game and in the second game.

The game controlled at the game apparatus is a game (for example, medal game) that consumes the credit as the game advances and grants credit depending on a result. In this game, because what is consumed and what is granted are both credit, players not interested in the content of the game are likely to increase. Therefore, various effects attainable in a mode in which the game controller controls the second game so as to advance automatically in accordance with a predetermined rule and in a mode in which the game controller controls the second game based on an instruction from the terminal device are more likely to be advantageous.

In this game apparatus, the credit storage device may store, as data indicating the number of credits, in association with the first identification information obtained by the obtainer, data indicating the number of the credits common to the first identification information and the second identification information corresponding to the first identification information, and the credit manager may increase or reduce the number of the credits depending on the credit consumed or granted, respectively, in the first game corresponding to the first identification information and in the second game corresponding to the second identification information. Alternatively, the credit storage device may store in association with the first identification information, as the data indicating the number of credits, data indicating the number of first credits corresponding to the first identification information obtained by the obtainer, and may store in association with the first identification information, as the data indicating the number of credits, data indicating the number of second credits that increases or decreases independently from the number of first credits, and the credit manager may increase or reduce the number of the first credits, depending on the credit consumed or granted in the first game corresponding to the first identification information, and may increase or reduce the number of the second credits depending on the credit consumed or granted in the second game corresponding to the second identification information that is associated with the first identification information.

In the game apparatus of the latter case, the credit manager may transfer the first credit corresponding to the first identification information to the second credit corresponding to the second identification information that is associated with the first identification information, or may transfer the second credit to the first credit. The transfer of a freely-selected or predetermined number of credits between the first and the second credits is reducing the number of credits on one side by a freely-selected or predetermined number of credits and increasing the same number of credits on the other side. When the number of the first or the second credits is plural, the number of credits transferred may be all or a part (one or a plurality) of the credits.

In each of the above game apparatuses, the game may grant, depending on a result of the game, non-credit that is not exchangeable for play as a reward that can be obtained depending on the result of the game, and the credit storage device may additionally store non-credit information indicating the granted non-credit and varying by the grant of the non-credit in the game, in association with the first identification information obtained by the obtainer, and the credit manager may change the non-credit information corresponding to the first identification information obtained by the obtainer depending on the non-credit granted respectively in the first game and the second game.

The “non-credit” is a reward obtained depending on a result of a game, and cannot be exchanged for a play, unlike the credit. However, the “non-credit” is also a game value. The non-credit is, for example, an item and a point. The item is, for example, a virtual item usable in a game such as a sword or costume. The examples of a point include those which can be exchanged for an item equivalent to the number of points and those for which a title equivalent to the number of points is conferred to a player. Thus, the “non-credit” can be considered as a “game value” as long as it is used in games. A medal game includes those types in which not only credit but also a point can be granted depending on a result of the game.

### BRIEF DESCRIPTION OF THE DRAWINGS

FIG. 1 is a block diagram of a game system 100 according to a first embodiment of the present invention.

FIG. 2 is a diagram showing the memory content of a storage device 11 in game system 100.

FIG. 3 is a block diagram of a station 3A in game system 100.

FIG. 4 is a block diagram of a setting terminal 4A in game system 100.

FIG. 5 is a diagram showing an operation of game system 100.

FIG. 6 is a diagram showing another operation of game system 100.

FIG. 7 is a block diagram of a game system 200 according to a second embodiment of the present invention.

FIG. 8 is a block diagram of a setting terminal 4A in game system 200.

### BEST MODE FOR CARRYING OUT THE INVENTION

### A: First Embodiment

### A-1: Configuration of First Embodiment

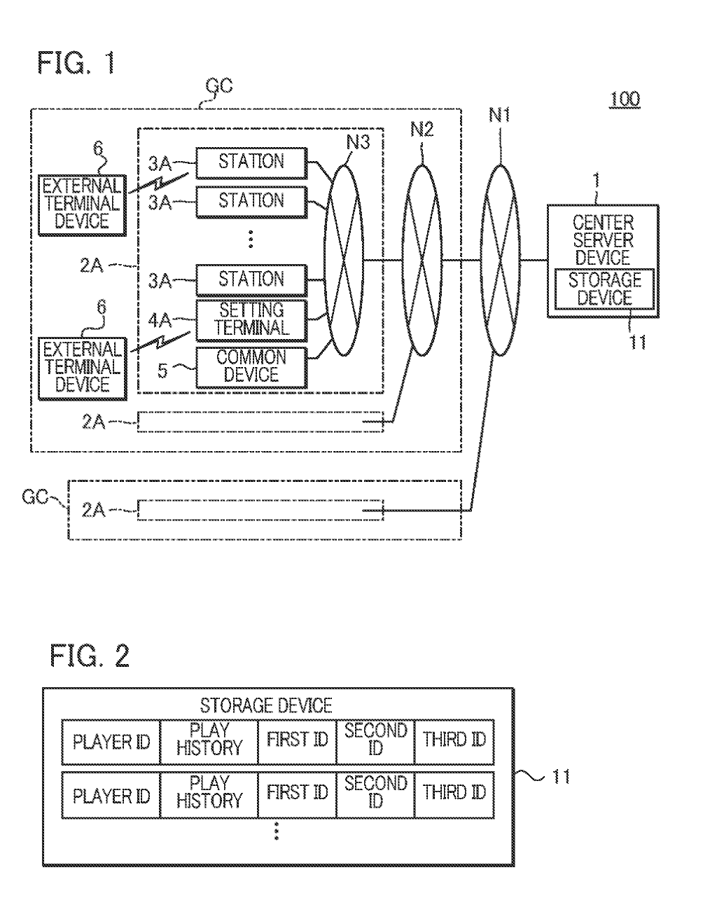

FIG. 1 is a block diagram of a game system 100 according to a first embodiment of the present invention. Game system 100 is a computer network system in which plural players (users) are able to play a game, and has plural game apparatuses 2A and a center server device 1.

Plural game apparatuses 2A are respectively sited at recreation facilities GC such as game centers. Each of these recreation facilities GC is connected to center server device 1 via a communication network N1. Each of plural game apparatuses 2A is capable of communicating with center server device 1 mutually via a communication network N2 and communication network N1, or via communication network N1. Communication network N1 is realized, for example, by a WAN (wide area network) and a VPN (virtual private network) using the Internet, and communication network N2 is realized by a LAN (local area network).

A game played in game system 100 advances while consuming credit, and is a game in which credit can be granted depending on a result of the game; specifically, a bingo game. The credit is a value to be exchanged for a gameplay, and is consumed when used in exchange for a play. That is, a player will repeatedly play a bingo game while consuming credit. In each round of the game, a mechanical drawing or lottery is performed in which a small number of numerals are selected from a large number of numerals. Prior to the lottery, a player can make a bet consuming a desired amount of credits. The more credits in a bet, the more credits that are anticipated depending on the game result.

Game apparatus 2A has plural stations 3A, plural setting terminals 4A, and a common device 5. Plural stations 3A, setting terminals 4A, and common device 5 can communicate with one another via communication network N3 provided in game apparatus 2A. Each of plural stations 3A, setting terminal 4A, and common device 5 can wirelessly communicate with an external terminal device 6, which is an external terminal device in a recreation facility GC where game apparatus 2A is sited. However, the present embodiment may be modified so that the number of stations 3A provided at game apparatus 2A is set to one.

Common device 5 is a device that controls the progress of a common process. A result of the common process is used in all games played at game apparatus 2A of which common device 5 is a part. Common device 5 repeatedly executes the common process, and when the common process ends, simultaneously transmits a result of the common process to all stations 3A and setting terminals 4A in game apparatus 2A. The common process controlled by common device 5 is, specifically, the above mechanical drawing.

The common process controlled by common device 5 is, specifically, a mechanical drawing in which one or a plurality of numerals is selected from multiple numerals. The method of the mechanical drawing can be freely selected. For example, common device 5 may be provided with a round board rotating around a vertical rotation axis and a mechanism for dropping one or plural balls on the board, the round board having multiple holes formed corresponding to the multiple numerals in the peripheral area thereof. Common device 5 may select, from the multiple numerals, those one or a plurality of numerals corresponding to a hole or holes into which the balls dropped on the board fall in.

External terminal device 6 is a portable device (computer) owned by a player and is a wireless LAN adapter compliant with IEEE802.11 series, being equipped with a web browser. Therefore, external terminal device 6 has a wireless LAN connection function. Such a device is, for example, a portable game device or a smart phone. A terminal ID is assigned to external terminal device 6. The terminal ID is identification information uniquely identifying external terminal device 6, and is assigned to each external terminal device 6. In the present embodiment, a MAC address is used as the terminal ID, but an IP address may be used. As the specification for the radio communication, Bluetooth or infrared communication can be employed.

Center server device 1 is a server device (computer) that manages players who are registered in advance and has a storage device 11. As shown in FIG. 2, storage device 11 stores, for each player who has registered, a player ID and a play history in association with each other. The player ID is identification information for uniquely identifying a player, and is assigned to a player who has registered. The play history is information indicating the history of the progress for a game played, and is a collection of pieces of information indicating how the player acted in which situation and which result was obtained.

Although not shown, the player ID of a player who has registered is associated with a medium ID of a portable medium owned by the player. Center server device 1 can receive the medium ID and return the player ID associated with the medium ID. The medium ID is identification information uniquely identifying a portable medium. The portable medium is, for example, an IC card or a portable phone, and each IC card has a unique medium ID recorded therein.

Storage device 11 stores, in association with a player ID, a first ID of station 3A or setting terminal 4A at which a player identified by this player ID is playing, a second ID of game apparatus 2A having the station 3A or the setting terminal 4A, and a third ID of recreation facility GC at which the game apparatus 2A is sited. The first ID is identification information uniquely identifying station 3A and setting terminal 4A in game apparatus 2A. The second ID is identification information uniquely identifying game apparatus 2A in recreation facility GC. The third ID is identification information uniquely identifying recreation facility GC.

### A-1-1: Configuration of Station 3A

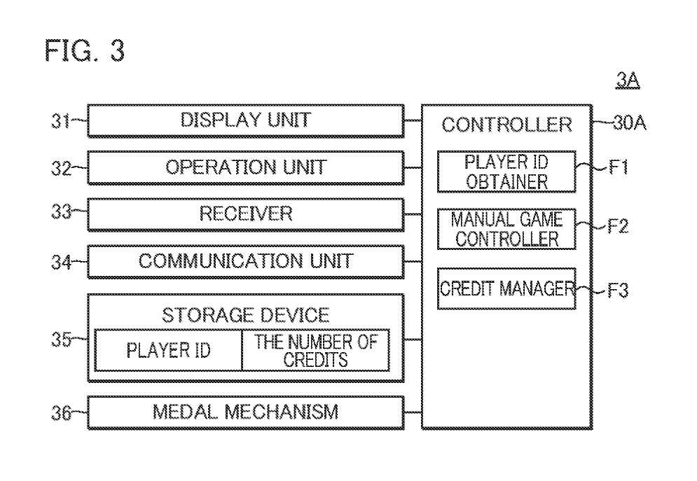

FIG. 3 is a block diagram of station 3A. Station 3A is a game apparatus (computer) for having a single player play a game, and has a display unit 31, an operation unit 32, a receiver 33, a communication unit 34, a storage device 35, a medal mechanism 36, and a controller 30A controlling each component.

Display unit 31 is, for example, a liquid crystal display device, and displays a progress status and a result of a game.

Operation unit 32 has, for example, an operator such as a button touched by a player and serves as an operation receiver that receives an operation of the player. The operation received by operation unit 32 includes an operation instructing the start of a play, an operation instructing the end of a play, an operation for the game, and an operation instructing the withdrawal of a medal.

Receiver 33 receives an input of a medium ID from a player. For example, a publically known reader for reading medium IDs recorded in IC cards is employed as receiver 33.

Communication unit 34 is a wired or wireless communication interface and is capable of communicating with the outside.

Storage device 35 is a rewritable memory or a storage device, and stores a player ID of one player who plays a game at station 3A, a terminal ID of an external terminal device 6 that is wirelessly connected with the station 3A, and the number of credits for the player in association with one another.

The number of credits decreases when credit is consumed, and it increases when credit is deposited from outside and when credit is granted depending on a result of a game. In the present embodiment, the deposit of credit from outside is performed as a result of physically inputting a medal, but it may be performed also as a result of electronic transfer and physical input of cash.

Medal mechanism 36 includes a medal detection sensor and a medal dispensing device. When a medal is inserted into a coin acceptance slot, each medal is detected by the medal detection sensor individually. Medal mechanism 36 notifies a detection signal to controller 30A, and accommodates the inserted coin to a container of the medal dispensing device. Medal mechanism 36 is controlled by controller 30A, and dispenses, from the medal dispensing device, medals accommodated in the container one by one from a dispenser. Although not shown, the coin acceptance slot and the dispenser are formed on the outer surface of station 3A. Controller 30A is configured by, for example, one or plural CPUs (central processing units) and serves as a player ID obtainer F1, a manual game controller F2, and credit manager F3.

Player ID obtainer F1 is a function unit that obtains a player ID of a player, and when receiver 33 receives an input of the medium ID, player ID obtainer F1 communicates with center server device 1 via communication unit 34, to obtain a player ID that is linked with the input medium ID from center server device 1. When player ID obtainer F1 obtains a player ID, controller 30A overwrites data in storage device 35 with the player ID and the number of credits of a player identified by this player ID in association with each other. Therefore, storage device 35 serves as a credit storage device that stores data indicating the number of credits with regard to a player ID obtained by player ID obtainer F1 in association with information (first identification information) showing the player ID.

Manual game controller F2 is a function unit that controls a game to be in association with a player ID obtained by player ID obtainer F1 and to advance based on an operation made to operation unit 32. The bingo game that advances based on an operation of operation unit 32 while consuming credit corresponding to the player ID obtained by player ID obtainer F1 will be hereinafter referred to as a “first game”. The bingo game performed in the first game advances based on a result of the common process (mechanical drawing).

Credit manager F3 is a function unit that manages credits. It controls medal mechanism 36 based on an operation of operation unit 32, but it basically performs a normal process. In this normal process, credit manager F3 reduces the number of credits stored in storage device 35 depending on credit consumed in the first game and medals dispensed by medal mechanism 36, whereas it increases the number of credits depending on medals input into medal mechanism 36 (depositing credit from outside) and credit granted in the first game. However, credit manager F3 performs an exception process when a totaling process of totaling the number of credits is performed. The totaling process and the exception process will be described later.

### A-1-2: Configuration of Setting Terminal 4A

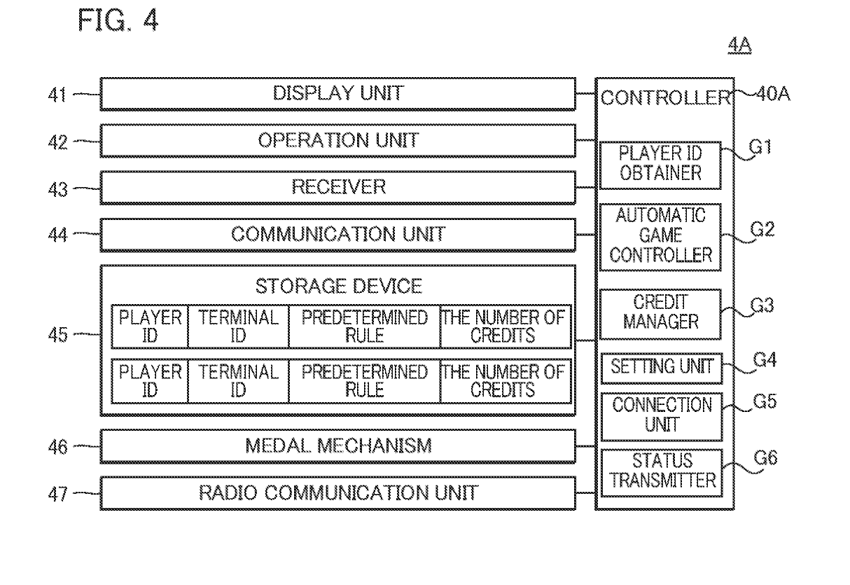

FIG. 4 is a block diagram of setting terminal 4A. Setting terminal 4A allows plural players to play (advance) automatic games, and it is a game apparatus (computer) for enabling various settings for an automatic game that is played, having a display unit 41, an operation unit 42, a receiver 43, a communication unit 44, a storage device 45, a medal mechanism 46, a radio communication unit 47, and a controller 40A controlling each component. The automatic game is a game that is controlled to advance automatically in accordance with a predetermined rule. The bingo game that is played in the automatic game also advances based on a result of the common process (mechanical drawing). Therefore, game results of the first game and the automatic game are determined based on the common process, and these games advance in synchrony with each other.

Display unit 41 is, for example, a liquid crystal display device, and displays a password used for authorization for connection with external terminal device 6 via radio communication unit 47.

Operation unit 42 has an operator such as a button touched by a player, and serves as an operation receiver that receives an operation by a player. Types of operations received by operation unit 42 include an operation for setting a predetermined rule and an operation for instructing the withdrawal of medals.

Receiver 43, communication unit 44, and medal mechanism 46 are the same as receiver 33, communication unit 34, and medal mechanism 36, respectively. However, although not shown, a coin acceptance slot and a dispenser for medals handled by medal mechanism 46 are formed on the outer surface of setting terminal 4A. The input of a medal is notified to controller 40A.

Storage device 45 is a rewritable memory or a storage device, and stores, for each player who plays an automatic game at setting terminal 4A, a player ID, a terminal ID, a predetermined rule, and the number of credits, in association with one another.

Radio communication unit 47 is a wireless LAN base unit (radio base unit) compliant with IEEE802.11 series, and it is capable of wirelessly communicating with the outside.

Controller 40A is configured of, for example, one or more CPUs, and serves as a player ID obtainer G1, an automatic game controller G2, a credit manager G3, a connection unit G5, a setting unit G4, and a status transmitter G6.

Player ID obtainer G1 is a function unit that obtains a player ID of a player. When an input of a medium ID is received at receiver 43, player ID obtainer G1 communicates with center server device 1 via communication unit 44, to obtain a player ID associated with the input medium ID from center server device 1. When player ID obtainer G1 obtains a player ID and in a case in which this player ID is not stored in storage device 45, controller 40A appends, in storage device 45, the player ID and the number of credits of a player identified by the player ID in association with each other. Therefore, storage device 45 serves as a credit storage device that stores data indicating the number of credits with regard to a player ID obtained by player ID obtainer G1 in association with information (first identification information) indicating the player ID.

Connection unit G5 is a function unit that enables the establishment of a connection with external terminal device 6 via radio communication unit 47. When a player ID is obtained by player ID obtainer G1, connection unit 6 issues a password corresponding to the player ID to cause display unit 41 to display the password, and obtains, from external terminal device 6, a password for confirmation input by a player. Connection unit 6 then stores in storage device 45, for external terminal device 6 for which the password for confirmation first agrees with the issued password, the player ID and a terminal ID of the external terminal device 6 in association with each other, and establishes a connection with this external terminal device 6. Therefore, storage device 45 serves as an identification information storage device that stores a player ID (first identification information) obtained by player ID obtainer G1 and a terminal ID (second identification information) assigned to external terminal device 6 with which a connection has been established by connection unit G5, in association with each other.

Automatic game controller G2 is a function unit that controls the automatic game. It controls one or a plurality of games respectively corresponding to one or a plurality of player IDs obtained by player ID obtainer G1, to automatically advance in accordance with a predetermined rule. Also, automatic game controller G2 controls plural games that are controlled, to advance simultaneously.

Automatic game controller G2 is also a function unit that controls a game to advance while consuming credit corresponding to a player ID corresponding to a terminal ID of external terminal device 6 for which a connection has been established by connection unit G5. Hereinafter, the bingo game that advances while consuming credit corresponding to a player ID corresponding to a terminal ID of external terminal device 6 for which a connection has been established by connection unit G5 will be referred to as a “second game”. In other words, automatic game controller G2 controls the second game in such a way that the game can advance automatically in accordance with a predetermined rule. The bingo game performed in the second game advances based on a result of the common process (mechanical drawing). Therefore, game results of the first game and the second game (automatic game) are determined based on the common process, and the first game and the second game advance in synchrony with each other.

As is obvious from the description on manual game controller F2 and automatic game controller G2, game apparatus 2A has a game controller that controls the first game and the second game so that the games can advance simultaneously, the first game advancing while consuming credit corresponding to a player ID obtained by ID obtainer F1 based on the operation of operation unit 32, and the second game advancing while consuming credit corresponding to a player ID corresponding to a terminal ID of external terminal device 6 for which a connection has been established by connection unit G5.

Setting unit G4 is a function unit that sets a predetermined rule. It sets a predetermined rule corresponding to a player ID obtained by player ID obtainer G1. More specifically, setting unit G4, when the input of medals into medal mechanism 46 ends, identifies a predetermined rule by prompting a player to select one of plural rules through display unit 41 and operation unit 42, to store in storage device 45 the identified predetermined rule in association with the player ID obtained by player ID obtainer G1.

The details of plural rules each can be freely selected. For example, plural rules may include a low-risk-and-low-return rule with a small number of credits consumed and a small number of credits anticipated to be awarded as a return, and a high-risk-and-high-return rule with a large number of credits consumed and a large number of credits anticipated to be awarded as a return. Also, setting unit G4 may identify a predetermined rule by prompting the above selection only once, or may alternatively identify a predetermined rule by prompting the above selection for each state (phase) of a game. A player first selects whether to let setting unit G4 identify a predetermined rule with one-time selection or to let setting unit G4 identify a predetermined rule by repeating selection for each game state. The player will make a selection only once in a case in which the player selects the former, and will perform selections plural times in a case in which the player selects the latter.

Credit manager G3 is a function unit that manages credits. It controls medal mechanism 46 based on an operation of operation unit 42 for the credit corresponding to a player ID obtained by player ID obtainer G1, and basically performs the normal process. In this normal process, credit manager G3 reduces the number of credits stored in storage device 45 when credit is consumed in an automatic game advancing while consuming credit corresponding to a player ID corresponding to the number of credits stored in storage device 45, and reduces the number of credits when a medal is withdrawn from medal mechanism 46 for the credit corresponding to the player ID. Credit manager G3 increases the number of credits when a medal is input to medal mechanism 46 for the credit corresponding to the player ID, and increases the credits when the credit is given in the automatic game. However, credit manager G3 performs the exception process instead of the normal process when the totaling process is performed.

The totaling process is a process in which the number of credits associated with the same player ID is totaled in game apparatus 2A, and is performed when a player ID of a player who is playing the first game is obtained by player ID obtainer G1 at game apparatus 2A (hereinafter referred to as the “first case”) and when a player ID of a player who is playing the automatic game is obtained by player ID obtainer F1 of station 3A at game apparatus 2A (hereinafter referred to as the “second case”).

The determination is made as to whether it is the first case that is realized, for example, by credit manager G3 referring to storage device 11 of center server device 1. In a case in which it is determined to be the first case, credit manager G3 performs the totaling process in cooperation with credit manager F3 of station 3A corresponding to a player ID obtained by player ID obtainer G1 in game apparatus 2A.

The determination is made as to whether it is the second case that is realized, for example, by credit manager F3 referring to storage device 11 of center server device 1. In a case in which it is determined to be the second case, credit manager F3 performs the totaling process in cooperation with credit manager G3 of setting terminal 4A of game apparatus 2A.

In the totaling process, for example, credit manager G3 deletes from storage device 45 the number of credits stored, in storage device 45, in association with a player ID obtained by player ID obtainer G1 (player ID obtained by player ID obtainer F1). Credit manager F3 overwrites the number of credits corresponding to this player ID in storage device 35, with the sum of the number of credits that was deleted and the number of credits in association with this player ID stored in storage device 35.

In this case, credit manager F3 and credit manager G3 perform the exception process. In the exception process, the number of credits stored in storage device 35 is reduced when credit is consumed in the first game, and when a medal is withdrawn from medal mechanism 36. Also, the number of credits is reduced when credit is consumed in the automatic game that advances while consuming credit corresponding to a player ID corresponding to the number of credits to be reduced, and is reduced when a medal is withdrawn from medal mechanism 46 for the credit corresponding to this player ID. On the other hand, the number of credits is increased when a medal is input to medal mechanism 36, and is increased when credit is granted in the first game. Also, the number of credits is increased when a medal is input to medal mechanism 46 for the credit corresponding to this player ID, and is increased when credit is granted in the automatic game.

In other words, credit manager F3 and credit manager G3 serve as a credit manager that reduces the number of credits corresponding to a player ID obtained by player ID obtainer G1 (player ID obtained by player ID obtainer F1) depending on credit consumed respectively in the first game and in the second game, regardless of whether the totaling process is performed. In a case in which the totaling process is performed, storage device 35 serves as a credit storage device that stores, in association with a player ID obtained by player ID obtainer F1, the number of credits that is common to this player ID and a terminal ID corresponding to the player ID. Credit manager F3 and credit manager G3 each serve as a credit manager that increases or reduces the number of credits depending on the consumption or grant of credit respectively in the first game corresponding to this player ID and the second game corresponding to the terminal ID.

Status transmitter G6 is a function unit that transmits, via radio communication unit 47, a game status to external terminal device 6 with which a connection has been established via connection unit G5.

Specifically, a web page indicating the progress status of a game is transmitted. That is, status transmitter G6 serves as a web server, and when it receives an HTTP (HyperText Transfer Protocol) request from a web browser of external terminal device 6, the status transmitter waits for the game progress status to be updated, generates data for describing a web page indicating the updated progress status of the game with a publicly known page description language, and replies with the data as a response to the request.

### A-2: Operation of First Embodiment

Description will be next given of an operation of game system 100 for different cases. A player ID and a play history for a player appearing in the following description are stored in storage device 11 of center server device 1. Station 3A and setting terminal 4A appearing in the following are provided at the same game apparatus 2A.

### A-2-1: Playing First Game Only

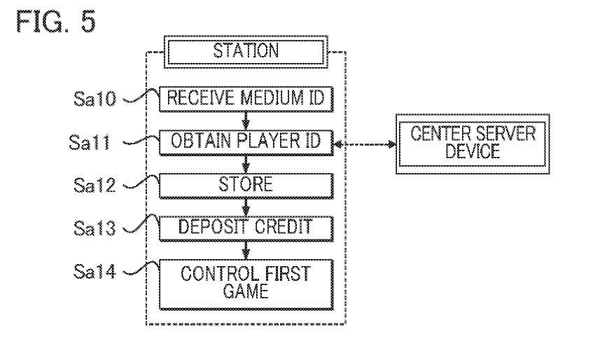

FIG. 5 is a diagram showing an operation in a case in which a player A who is not playing a game and is going to play the first game by entering a medium ID at an available station 3A. As shown in this diagram, at the available station 3A, receiver 33 first receives an input of a medium ID associated with a player ID of player A (Sa10). Player ID obtainer F1 obtains a player ID associated with this medium ID from center server device 1 (Sa11), and controller 30A overwrites storage device 35 with this player ID and the number of credits of a player identified by this player ID (Sa12).

Next, player A inputs a medal into station 3A, and credit manager F3 increases the number of credits stored in storage device 35 in response to the input (Sa13). After this, manual game controller F2 controls the first game (Sa14). The first game is associated with a player ID obtained by player ID obtainer F1, and advances based on an operation of operation unit 32, using a result of the common process. In the first game, credit manager F3 reduces the number of credits stored in storage device 35 depending on credit consumed in the first game, and increases the number of credits depending on credit granted in the first game.

The above-described operation also applies to a case in which a player other than player A is playing the first game at another station 3A, and also applies to a case in which a player other than player A is playing the second game at setting terminal 4A. Thus, game apparatus 2A is capable of advancing plural first games simultaneously, and of advancing the first game and the second game simultaneously.

### A-2-2: Playing Second Game Only

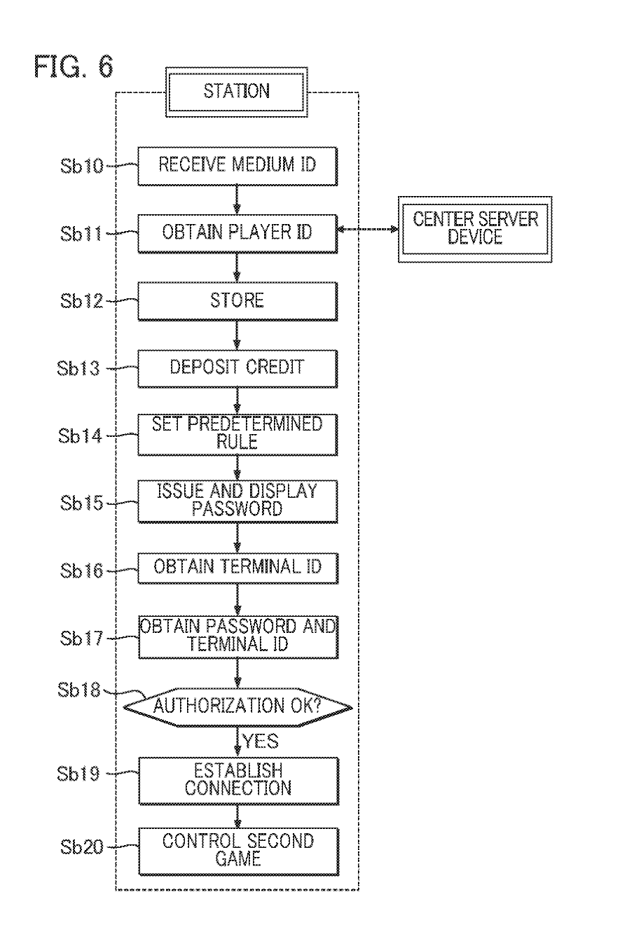

FIG. 6 is a diagram showing an operation in which player A is not playing the first game but is going to play the second game by inputting the medium ID to setting terminal 4A. As shown in this diagram, at setting terminal 4A, receiver 43 first receives the input of the medium ID associated with the player ID of player A (Sb10). Player ID obtainer G1 then obtains the player ID associated with the medium ID from center server device 1 (Sb11). Controller 40A then appends to storage device 45 the player ID and the number of credits identified by a player of the player ID in association with each other (Sb12).

Player A then inputs a medal into setting terminal 4A, and credit manager G3 increases the number of credits stored in storage device 45 (Sb13) in response to the input. Setting unit G4 then sets a predetermined rule in association with the player ID obtained by player ID obtainer G1 (Sb14). Specifically, setting unit G4 uses display unit 41 and operation unit 42 to prompt a player to select one of plural rules, to identify the predetermined rule, and causes storage device 45 to store the identified predetermined rule in association with the player ID obtained by player ID obtainer G1.

Next, connection unit G5 issues a password by associating with the player ID obtained by player ID obtainer G1, and causes display unit 41 to issue the password (Sb15). Subsequently, player A uses a wireless LAN connection function of external terminal device 6 to search a base unit (access point) corresponding to setting terminal 4A based on a network identifier (SSID) thereof, and requests a connection. Connection unit G5 of setting terminal 4A then obtains a terminal ID of external terminal device 6 that has requested the connection (Sb 16).

Connection unit G5 then obtains a password for confirmation input by the player from external terminal device 6 that has requested the connection (Sb17). Specifically, via radio communication unit 47, connection unit G5 prompts external terminal device 6 for the input and the transmission of the password, to receive the transmitted password for confirmation from external terminal device 6. When this is received, connection unit G5 reacquires the terminal ID of external terminal device 6.

Connection unit G5 establishes a connection with external terminal device 6 (Sb19) only when the obtained password for confirmation agrees with the password associated with the player ID obtained by player ID obtainer G1 and when the terminal ID obtained in obtaining the password for confirmation agrees with the terminal ID of external terminal device 6 that has first requested for connection since the password was issued, i.e., only when it is authorized that the player is a valid player (Sb18: YES).

The agreement of not only the password but also the terminal ID is required to reduce the probability of a third party obtaining the password and successfully establishing a connection. Therefore, it may be configured such that the agreement of only the password is required, depending on a requested security level. Also, it may be configured so that the password for confirmation is obtained only from external terminal device 6 that has first requested since the password was issued. A one-time-use password may be used as a password, to further enhance the security level.

Next, automatic game controller G2 controls the progress of the second game (Sb20). This second game is associated with the terminal ID of external terminal device 6 for which the connection has been established by connection unit G5 and the player ID obtained by player ID obtainer G1. The second game advances in accordance with a predetermined rule that is set in association with the player ID and advances using a result of the common process. In the second game, credit manager G3 reduces the number of credits stored in storage device 45 depending on credit consumed in the second game, and increases the number of credits depending on credit granted in the second game. Furthermore, in the second game, status transmitter G6 transmits a progress status of the game to external terminal device 6 for which the connection has been established via connection unit G5.

The above-described operation is performed when a player other than player A plays the second game at setting terminal 4A. Thus, setting terminal 4A is capable of simultaneously advancing plural second games respectively corresponding to plural players. Also, the above-described operation is performed also when a player other than player A plays the first game at station 3A. This also means that game apparatus 2A is capable of simultaneously advancing the first game and the second game.

### A-2-3: Playing First Game and Second Game Simultaneously

### 2-3-1: Starting Play of First Game Afterward

An operation that is performed in a case in which player B inputs the medium ID associated with the player ID of player A to station 3A to play the first game while player A is playing the second game is the same as that indicated in FIG. 5. However, in this case, the totaling process is performed, and credit manager F3 of station 3A and credit manager G3 of setting terminal 4A perform the exception process. Accordingly, the number of credits stored in storage device 35 of station 3A will be the number of credits common to the first game and the second game, will decrease depending on credit consumed respectively in the first game and the second game, and will increase depending on credit granted respectively in the first game and the second game.

### A-2-3-2: Starting Play of Second Game Afterward

An operation that is performed in a case in which player B inputs the medium ID associated with the player ID of player A to setting terminal 4A to play the second game while player A is playing the first game is the same as that indicated in FIG. 6. However, in this case, the totaling process is performed, so that credit manager F3 of station 3A and credit manager G3 of setting terminal 4A preform the exception process. Therefore, the number of credits stored in storage device 35 of station 3A will be the number of credits common to the first game and the second game, will decrease depending on credit consumed in the first game and the second game, and will increase depending on credit granted respectively in the first game and the second game.

### A-3: Conclusion of First Embodiment

As described above, game apparatus 2A is capable of uniquely identifying a player and reducing the number of credits for this player depending on credit consumed in games (the first game and the second game) that can simultaneously advance for this player. Also, the first game is controlled based on an operation of operation unit 42, whereas the second game is controlled based not on the operation of operation unit 42 but in association with a player ID corresponding to terminal ID of external terminal device 6 for which a connection has been established. Therefore, a player is able to play the second game by using external terminal device 6 even at a place remote from game apparatus 2A (for example, a smoking area at a game center).

Also, according to game apparatus 2A, it is possible to simultaneously progress the first game based on an operation of operation unit 42 and the second game not based on the operation of the operation unit. Therefore, a player can play the second game even when station 3A is not available.

Also, according to game apparatus 2A, a single player can simultaneously play the first game and the second game. In this case, the first game advances while consuming credit corresponding to a player ID of the player, and the second game advances while consuming credit corresponding to the player ID corresponding to the terminal ID. Therefore, the number of player IDs required is one. Therefore, in comparison with a case in which multiple player IDs are assigned to a single player and are used in implementing the simultaneous play of plural games by using these player IDs, the work necessary for obtaining a player ID can be reduced, and the management of player IDs can be made simpler.

Also, according to game apparatus 2A, while a player is playing the first game, another player is able to play the second game in association with the same identification information as that of the player playing the first game. Therefore, because a result of the first game played and a result of the second game played can be managed in association with the same identification information, it is possible to meet various demands of players. For example, friends will be able to cooperatively play a game. Also, if types of games to be controlled are different among plural game apparatuses 2A, or if one of plural types of games can be selected respectively at each game apparatus 2A, a single player can simultaneously play plural types of games (simultaneous gameplays by a single player).

Also, according to game apparatus 2A, because a game is controlled based on a result of the common process at station 3A and setting terminal 4A, either the automatic game or the first game (manual game) will not precede the other. That is, the game progress at station 3A and the game progress at setting terminal 4A can be synchronized with each other.

The game can be automatically advanced at setting terminal 4A. Credit can be granted based on a result even in the automatic game that automatically advances. Therefore, a player would be satisfied even if a game advances automatically if the player is not interested in the content of a game (if the player focuses only on a result of the game (grant of credit)). Also, in a game apparatus loaded with a chance game such as a jackpot game and a bonus game in which a large number of game values can be obtained depending on a game result, some players may wish to have a game advance automatically until a chance game is started. Furthermore, in participating in a chance game, in a case in which those able to participate need to have played a game for a certain period, some players may wish to have a game advance automatically so that the qualifications for participation can be obtained. Also, at setting terminal 4A, automatic games can be advanced for plural players simultaneously. Therefore, plural players can be given chances to play an automatic game because setting terminal 4A will not be occupied by a player who is not interested in the content of a game playing the game.

Also, according to setting terminal 4A, because a predetermined rule is set for each player ID, the progress content of the automatic game can be made different for each player, so that the intention of the player can be reflected to the game to some extent. This will contribute to the increase of players who have the game advance automatically. Also, according to setting terminal 4A, a player can use external terminal device 6 to know the progress status of the automatic game (the second game).

A game that is controlled according to the present embodiment is a medal game that uses credit when the game advances and grants credit depending on a result. In a medal game, because those that are consumed and granted are both credits, and increasing credits will be the significant purpose of the game, there will likely be more players who are not interested in the content of the game. Therefore, the present embodiment has advantages in that the above various effects are more likely to be more beneficial.

### B: Second Embodiment

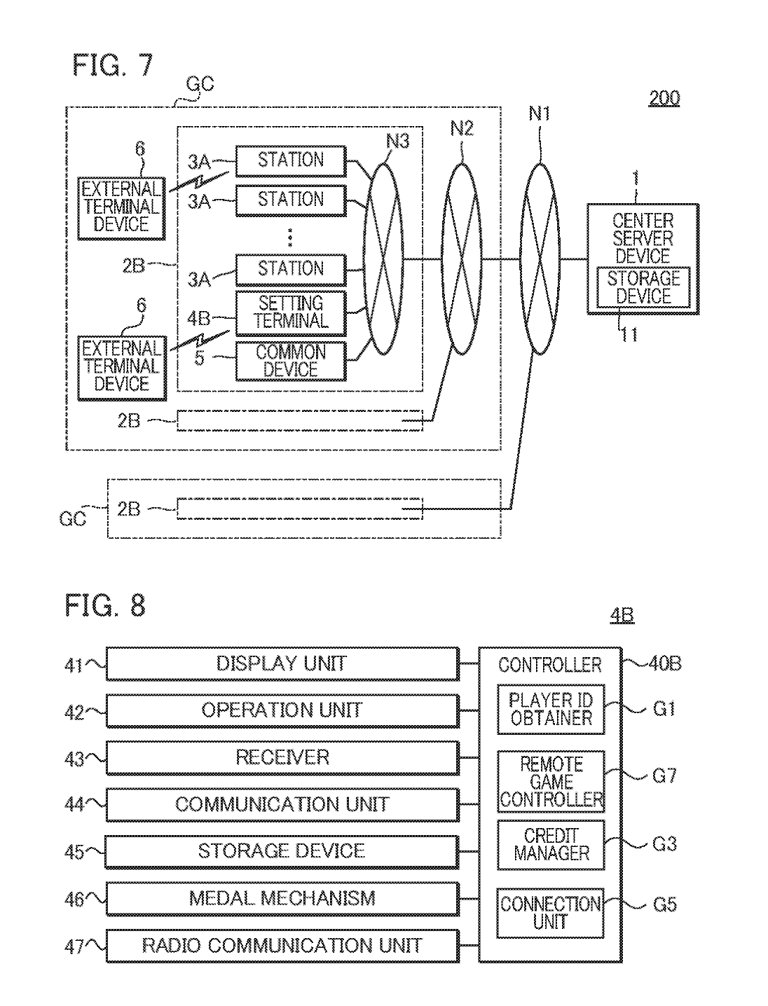

FIG. 7 is a block diagram of a game system 200 according to a second embodiment of the present invention. Game system 200 differs from game system 100 only in that game system 200 has game apparatus 2B instead of game apparatus 2A. Game apparatus 2B differs from game apparatus 2A only in that game apparatus 2B has setting terminal 4B instead of setting terminal 4A.

FIG. 8 is a block diagram of setting terminal 4B. Setting terminal 4B differs from setting terminal 4A only in that setting terminal 4B has controller 40B instead of controller 40A. Controller 40B differs from controller 40A only in that controller 40B does not serve as setting unit G4 or status transmitter G6 and in that controller 40B does not serve as automatic game controller G2 but serves as remote game controller G7. Because controller 40B does not serve as setting unit G4, a predetermined rule will not be stored in storage device 45.

Remote game controller G7 is a function unit that controls the second game based on an instruction from external terminal device 6 for which a connection has been established by connection unit G5. That is, the second game controlled by remote game controller G7 is not the automatic game but is a “remote game” controlled based on an instruction from external terminal device 6. Furthermore, remote game controller G7 is a function unit for controlling one or plural remote games respectively corresponding to one or plural player IDs obtained by player ID obtainer G1 so that these games progress simultaneously.

Also, remote game controller G7 has the same function as status transmitter G6, and has a function of receiving an instruction from external terminal device 6 for which a connection has been established via connection unit G5.

As is obvious from the above description, game apparatus 2B has a game controller that controls the first game based on the operation of operation unit 32, as is the case with game apparatus 2A, while consuming credit corresponding to a player ID obtained by player ID obtainer F1 and the second game while consuming credit corresponding to a player ID associated with a terminal ID of external terminal device 6 for which a connection has been established via connection unit G5 so that the games progress simultaneously.

As is obvious from the above description, game apparatus 2B can produce the same effects as game apparatus 2A except for the effects relating to the automatic game. Also, according to game apparatus 2B, a player can operate the second game using external terminal device 6. That is, according to game apparatus 2B, it is possible to increase the opportunities for a player who is interested in the content of the game to play.

### C: Modification

The present invention may include in its scope not only the above embodiments but also various embodiments obtained by modifying the above embodiments and also those that are obtained by appropriately combining two or more of these embodiments and the above embodiments.

### C-1: Modification 1

In each embodiment, the number of credits is managed by being totaled, but may be managed without being totaled. That is, the credit storage device may store data indicating the number of first credits in association with a player ID obtained by player ID obtainer F1 in storage device 35, whereas the credit storage device may store the number of second credits increasing or decreasing independently from the number of first credits in association with the same player ID in storage device 45. The credit manager may increase or reduce the number of first credits depending on credit consumed or granted in the first game corresponding to the player ID, whereas the credit manager may increase or reduce the number of second credits depending on credit consumed or granted in the second game corresponding to a terminal ID associated with the player ID.

### C-2: Modification 2

In Modification 1, it may be configured so that the credit manager is able to transfer all or a part of credits between the first credit and the second credit. That is, in a case in which the credit manager transfers credits from the first credit to the second credit, the credit manager reduces the number of the first credits and increases the number of the second credits by the number of credits to be transferred. Conversely, in a case in which the credit manager transfers credits from the first credit to the second credit, the credit manager reduces the number of second credits and increases the number of first credits by the number of credits to be transferred. A player may be prompted to specify the number of credits to be transferred. In this mode, credits can be transferred without a player handling actual medals.

C-3: Modification 3

In the first embodiment, it may be configured so that controller 30A does not serve as connection unit G5 and status transmitter G6. According to this embodiment, a player can play the automatic game without using external terminal device 6. However, in this mode, a player playing the second game is not able to know the progress status of the second game. Nevertheless, a player who is not interested in the content of the game (a player who focuses only on a game result) would be satisfied even if the player is not able to know the progress status of the second game.

### C-4: Modification 4

In each embodiment, a bingo game is controlled. However, other games (for example, a horse racing game, a mahjong game, and a role playing game) may be controlled. Also, in each of the above-described embodiments, a game involving mechanical drawing is controlled. However, a game not involving mechanical drawing (for example, a game involving a computerized drawing or a lottery or a game not involving a lottery) may be controlled. In a case in which a game not involving mechanical drawing is controlled, each game apparatus may employ a configuration not including the common device.

### C-5: Modification 5

In each of the above embodiments, a player is able to play the second game until credit runs out. However, it may be configured so that a player is no longer able to play the second game even if credit is still remaining in a specific case. For example, repeatedly played games are divided into a normal game permitting the second gameplay and a special game not permitting the second gameplay. In this case, a player is able to play the second game either until credit runs out or until a special game starts. Such a special game includes a game with elaborated dramatic interpretation that is performed when a predetermined condition is satisfied. Also, a given rule may be determined such as providing a set number of credits as a condition for ending the automatic game. In this case, the automatic game ends in a case in which the increase or decrease in the number of credits that increases or decreases with the automatic gameplay becomes equal to or greater than the set number of credits or equal to or less than the set number of credits.

### C-6: Modification 6

In each of the above-described embodiments, a medal game in which credits can be granted depending on a result is controlled. However, a game (for example, a video game) in which game values (non-credit) other than credits can be granted as rewards depending on a result may be a game to be controlled. A medal game in which not only the credit, but also the non-credit, can be granted depending on a result may be a game to be controlled.

The “non-credit” is, for example, items or points. Such an item includes a virtual object such as a sword and costume usable in a game. Such a point includes that which can be exchangeable with an item corresponding to the number of points and a title corresponding to the number of points, the title being granted to a player.

In a case in which the non-credit is an item, the credit storage device additionally stores, in association with a player ID obtained by the player ID obtainer, item information that indicates granted items and that varies depending on an item granted in a game. The credit manager will change item information corresponding to the player ID obtained by the player ID obtainer, depending on an item granted respectively in the first game and in the second game.

In a case in which the non-credit is a point, the credit storage device additionally stores, in association with a player ID obtained by the player ID obtainer, the number of points that increases depending on the grant of points in a game. The credit manager increases the number of points corresponding to a player ID obtained by the player ID obtainer depending on the grant of points respectively in the first game and the second game.

### C-7: Modification 7

In each of the above-described embodiments, a predetermined rule is set for each player who plays the automatic game. However, a predetermined rule may be set in common for plural players who play that automatic game. In this case, each of plural automatic games controlled by the setting terminal will progress in accordance with the common rule.

### C-8: Modification 8

In the first embodiment, setting unit G4 may set, based on a play history corresponding to a player ID out of play histories stored in center server device 1, a predetermined rule in association with the player ID or another player ID. Another player ID is preferably a player ID that is in a predetermined relationship with the player ID with which a predetermined rule is associated. In this case, center server device 1 stores data indicating the relationships among player IDs, and setting unit G4 identifies, based on this data, a player ID that is in a predetermined relationship with the player ID with which the predetermined rule is to be associated. Such a predetermined relationship includes a friendship, and the engagement thereof is performed, for example, through communication between two stations at which two players who will engage the relationship are respectively playing.

### C-9: Modification 9

In the first embodiment, as a predetermined rule to be set in association with a player, a predetermined rule may be employed such that the automatic game that progresses while consuming credit corresponding to a player ID is made corresponding to the progress status of a game that progresses while consuming credit corresponding to another player ID. Another player ID is preferably a player ID that has a predetermined relationship (for example, friendship) with a player ID with which a predetermined rule is associated. For example, center server device 1 stores data indicating relationships among player IDs, and collects, for each player ID corresponding to the automatic game, the progress status of a game corresponding to another player ID that is in a predetermined relationship with each player ID corresponding to the automatic game. Setting unit G4 controls, out of the progress statues collected by center server device 1, the automatic game so as to correspond to the progress status for another player ID that is in a predetermined relationship with the player ID with which a predetermined rule is to be set.

### C-10: Modification 10

In each of the above-described embodiments, medals are dispensed.

However, a number of tickets (or coupons or vouchers) corresponding to the number of credits may be dispensed instead of medals. In this case, the correspondence between the number of tickets and the number of credits can be freely selected in such a way that one ticket is equivalent to ten credits. Additionally, external terminal device 6 may be one not loaded with a web browser. In this case, the second game needs to be installed in advance so that the second game is executed in external terminal device 6. Thus, a mode of software for enabling the execution of the second game at external terminal device 6 can be freely selected.

### C-11: Modification 11

In each of the above-described embodiments, the player ID obtainer for obtaining a player ID obtains a player ID associated with a medium ID. However, the medium ID may be used as the player ID. In this case, the receiver serves as the player ID obtainer. Also, the input unit (for example, a keyboard) for a player for directly inputting the player ID may serve as the player ID obtainer. Also, in each of the above-described embodiments, player IDs are stored in the station and the setting terminal, and it may be configured so that player IDs are not stored in the station or in the setting terminal. However, also in this case, because the first ID is assigned to the station and the setting terminal and the first ID is associated with a player ID, a game that progresses at the station or at the setting terminal and the number of credits stored in the station or in the setting terminal will correspond to the player ID.

### C-12: Modification 12

In the first embodiment, the common device may additionally have an outputter for outputting a result or a status of the common process to the outside. The output destination of the outputter can be, for example, a monitor provided in recreation facilities. In this case, a player is able to know a result or a status of the common process even at a remote location. This is especially beneficial for a player who plays an automatic game without using external terminal device 6 at a remote location and is interested in a result or a status of the common process.

### C-13: Modification 13

In each embodiment, when a player plays this game apparatus for the first time and when the play is performed in the second game, it may be configured so that it is possible to play the game without consuming credit in exchange for the play for a predetermined number of games. That is, it is possible to provide a free trial play in the second game. Especially in the first embodiment, because the second game is advanced by the automatic play, it is possible to learn a play method in a free trial. Therefore, new players can be gained. Specifically, when a connection has been established with a terminal device by the connection unit and when it is determined that the first identification information obtained by the information obtainer has not been used for the play so far at the game apparatus, the game controller controls the game so as to permit the play without consuming credit for a predetermined number of games. Also, when the above determination is performed, the predetermined number of credits may be granted. To determine whether the first identification information obtained by the obtainer has not been used for the play at the game apparatus so far, the history of the first identification information of a player who played may be stored.

### DESCRIPTION OF THE REFERENCE NUMERALS

1 . . . center server device, 2A,2B . . . game apparatus, 3A . . . station, 4A,4B . . . setting terminal, 5 . . . common device, 6 . . . external setting terminal, 11,35,45 . . . storage device (credit storage device, identification information storage device), 30A,40A,40B . . . controller, 31,41 . . . display unit, 32,42 . . . operation unit (operation receiver), 33,43 . . . receiver, 34,44 . . . communication unit, 36,46 . . . medal mechanism, 47 . . . radio communication unit, 100,200 . . . game system, F1,G1 . . . player ID obtainer, F2 . . . manual game controller, F3,G3 . . . credit manager, G2 . . . automatic game controller, G4 . . . setting unit, G5 . . . connection unit, G6 . . . status transmitter, G7 . . . remote game controller.

1. A game apparatus comprising:
an obtainer that obtains first identification information for uniquely identifying a player;
a credit storage device that stores data indicating the number of credits for the first identification information obtained by the obtainer in association with the first identification information;
a credit manager that increases the number of credits indicated by the data stored in the credit storage device by the deposit of credit from the outside and reduces the number of credits by the consumption of credit in exchange for a game play;
a radio communication unit adapted to perform radio communication;
a connection unit that establishes a connection with an external portable terminal device via the radio communication unit;
an identification information storage device that stores the first identification information obtained by the obtainer and second identification information assigned to the terminal device for which the connection has been established by the connection unit, the first identification information and the second identification information being stored in association with each other;
an operation receiver that receives an operation of a player with respect to the game; and
a game controller that controls a first game and a second game so that the first game and the second game advance simultaneously, the first game advancing based on the operation received at the operation receiver and advancing while consuming credit corresponding to the first identification information obtained by the obtainer and the second game advancing while consuming credit corresponding to the first identification information associated with the second identification information assigned to the terminal device for which the connection has been established by the connection unit,
wherein the credit manager reduces the number of the credits corresponding to the first identification information obtained by the obtainer depending on the consumption of credits respectively in the first game and in the second game.

2. A game apparatus according to claim 1, further comprising:
a status transmitter that transmits a progress status of the second game to the terminal device via the radio communication unit,
wherein the game controller controls the second game to advance automatically in accordance with a predetermined rule.

3. A game apparatus according to claim 1,
wherein the game controller controls the second game based on an instruction from the terminal device.

4. A game apparatus according to claim 1,
wherein the connection unit, in a case in which the first identification information is obtained by the obtainer, issues a password in association with the first identification information for display, and stores the first identification information and the second identification information in association with each other in the identification information storage device for the terminal device for which the password first agrees with a password for confirmation obtained from the terminal device since the password was issued, thereby establishing a connection with the terminal device.

5. A game apparatus according to claim 1,
wherein the game grants credit depending on a result of the game as a reward that can be obtained depending on the result of the game; and
wherein the credit manager increases or reduces the number of the credits corresponding to the first identification information obtained by the obtainer depending on the consumption or the grant of credit respectively in the first game and in the second game.

6. A game apparatus according to claim 5,
wherein the credit storage device stores, as data indicating the number of credits, in association with the first identification information obtained by the obtainer, data indicating the number of the credits common to the first identification information and the second identification information corresponding to the first identification information; and
wherein the credit manager increases or reduces the number of the credits depending on credit consumed or granted respectively in the first game corresponding to the first identification information and in the second game corresponding to the second identification information.

7. A game apparatus according to claim 5,
wherein the credit storage device stores in association with the first identification information, as the data indicating the number of credits, data indicating the number of first credits corresponding to the first identification information obtained by the obtainer, and stores in association with the first identification information, as the data indicating the number of credits, data indicating the number of second credits that increases or decreases independently from the number of first credits; and
wherein the credit manager increases or reduces the number of first credits, depending on the credit consumed or granted in the first game corresponding to the first identification information, and increases or reduces the number of the second credits depending on the credit consumed or granted in the second game corresponding to the second identification information that is associated with the first identification information.

8. A game apparatus according to claim 7,
wherein the credit manager transfers the first credit corresponding to the first identification information to the second credit corresponding to the second identification information that is associated with the first identification information or transfers the second credit to the first credit.

9. A game apparatus according to claim 1,
wherein the game grants, depending on a result of the game, non-credit that is not exchangeable for play as a reward that can be obtained depending on the result of the game;
wherein the credit storage device further stores, in association with the first identification information obtained by the obtainer, non-credit information indicating the granted non-credit and varying by the grant of the non-credit in the game; and
wherein the credit manager changes the non-credit information corresponding to the first identification information obtained by the obtainer depending on the non-credit granted respectively in the first game and the second game.
